(19) United States
(12) Patent Application Publication
(10) Pub. No.: US 2015/0048968 A1
(43) Pub. Date: Feb. 19, 2015

(54) IN-VEHICLE RADAR APPARATUS AND TARGET DETECTION METHOD THEREOF

(71) Applicant: DENSO CORPORATION, Kariya-city (JP)

(72) Inventors: Ryusuke Uyama, Kariya-shi (JP); Keiji Matsuoka, Nagoya (JP)

(73) Assignee: DENSO CORPORATION, Kariya-city (JP)

(21) Appl. No.: 14/387,808

(22) PCT Filed: Mar. 15, 2013
(86) PCT No.: PCT/JP2013/057490

§ 371 Date: Sep. 24, 2014

(30) Foreign Application Priority Data
Mar. 28, 2012 (JP) 2012-074643

(51) Int. Cl. G01S 13/58; G01S 7/02

(52) U.S. Cl. CPC G01S 13/58; G01S 7/02
USPC 342/109

(57) ABSTRACT

In an in-vehicle radar apparatus, a signal processing unit calculates a change curve shape of power values of the reception power of the radio waves received by a receiving unit in relation to the distance from the own vehicle when the speed of the own vehicle acquired by a speedometer is a predetermined value or lower and the distance from the own vehicle to the target measured by a measuring unit is a predetermined value or less, and determines a portion of the change curve shape as a target to be detected. The portion indicates a local maximum value or an inflection value of the power values of which a difference in power with a maximum value is within a certain range, among local maximum values or inflection values of the power values at distances closer to the own vehicle than the maximum value of the power values.

### CROSS REFERENCE TO RELATED APPLICATIONS

This application is a U.S. National Phase application under 35 U.S.C. 371 of International Application No. PCT/JP2013/057490 filed on Mar. 15, 2013 and published in Japanese as WO 2013/146375 A1 on Oct. 3, 2013. This application is based on and claims the benefit of priority from Japanese Patent Application No. 2012-074643 filed on Mar. 28, 2012. The entire disclosures of all of the above applications are incorporated herein by reference.

### BACKGROUND

1. Technical Field

The present invention relates to an in-vehicle radar apparatus, such as a millimeter-wave radar, that is mounted in a vehicle. In particular, the present invention relates to an in-vehicle radar apparatus that transmits radio waves in a forward direction from a vehicle, receives reflected waves of the transmitted radio waves from a target, such as a preceding vehicle, detects distance, relative speed, orientation, and the like of the target by signal processing, and performs detection without losing the target even in close proximity to the preceding vehicle, and a target detection method thereof.

2. Background Art

Conventionally, an inter-vehicle control apparatus is known that uses a millimeter-wave radar as an in-vehicle radar that is mounted in a vehicle. For example, the in-vehicle radar transmits radio waves in a forward direction of the vehicle from a transmission antenna using a radar system, such as a frequency modulated continuous wave (FMCW) system. The in-vehicle radar receives, by a reception antenna, reflected waves of the transmitted waves reflected by a target present ahead of the vehicle. The in-vehicle radar then measures distance, relative speed, orientation, and the like of the target from reception signals of the reflected waves, thereby detecting a preceding vehicle as the target. The inter-vehicle control apparatus controls vehicle cruising to maintain a fixed inter-vehicle distance with the preceding vehicle detected by the in-vehicle radar.

In an inter-vehicle control apparatus such as this, ordinarily, the beam width in the up/down direction of the radio waves outputted from the in-vehicle radar is narrowed. Therefore, for example, when a preceding vehicle having a high vehicle height is approached, the preceding vehicle leaves the detection range of the beam. The preceding vehicle is lost as a target that can be measured by the reflected waves. The preceding vehicle may not be accurately detected as a target.

Here, as a prior art in response to the occurrence of a situation in which the preceding vehicle cannot be accurately detected as a target upon approach in this way (referred to, hereinafter, as proximity loss), for example, an in-vehicle radar described in PTL 1 is known. To prevent proximity loss of the target, the in-vehicle radar apparatus uses a configuration in which the beam direction of the transmitted radio waves is changed when the inter-vehicle distance with the preceding vehicle measured by the radar is within a distance at which proximity loss may occur, the inter-vehicle distance is changing to become shorter, and reception output of the radar nears a level enabling detection of the target.

### PTL 1

JP-A-2003-121542

However, in the above-described in-vehicle radar apparatus, a mechanism for changing the beam direction of the output radio waves, such as a mechanism for mechanically turning an antenna to an elevation direction, a plurality of antenna elements for forming a phased array antenna, and a phase shifter are required to be provided. Therefore, a problem occurs in that the structure of the in-vehicle radar apparatus becomes complex and reliability also deteriorates.

### SUMMARY

The present invention has been achieved in light of such problems. An object of the present invention is to provide an in-vehicle radar apparatus and a target detection method thereof capable of preventing proximity loss even when approaching a target and accurately detecting the target, using a simple and highly reliable structure.

An in-vehicle radar apparatus according to a first aspect of the present invention includes transmitting means, receiving means, measuring means, speed acquiring means, shape calculating means, and determining means.

The transmitting means transmits, in a forward direction of an own vehicle, radio waves having a predetermined beam width in a vertical direction. The receiving means receives, from a target positioned ahead of the own vehicle, reflected waves of the radio waves outputted from the transmitting means. The measuring means measures a distance from the own vehicle to the target based on reception power of the reflected waves received by the receiving means

The speed acquiring means acquires the speed of the own vehicle. The shape calculating means measures power values of the reception power of the reflected waves received by the receiving means in relation to the distance from the own vehicle and calculates a change curve shape of the measured power values. The determining means determines, as a target to be detected, a portion of the change curve shape of the power values calculated by the shape calculating means, when the speed of the own vehicle acquired by the speed acquiring means is a predetermined value or less and the distance from the own vehicle to the target measured by the measuring means is a predetermined value or less. The portion of the change curve shape indicates, among local maximum values or inflection values of the power values at distances closer to the own vehicle than a maximum value of the power values, a local maximum value or inflection value of the power values of which a difference in power with the maximum value of the power values is within a predetermined range.

According to an in-vehicle radar apparatus such as this, proximity loss can be prevented even when a target is approached, using a simple and highly reliable structure. The reasons therefor will be described hereafter.

When the receiving means receives the reflected waves of the radio waves transmitted from the transmitting means from the preceding vehicle, the distance to the preceding vehicle can be measured, for example, by use of delay times in pulse waves or beat signal frequencies in the FMCW system.

At this time, when the own vehicle and a preceding vehicle (target) stop, such as at a red light, the own vehicle approaches the preceding vehicle while decelerating. Then, for example, when the own vehicle approaches a stopped preceding vehicle that has a high vehicle height, the rear end portion of the preceding vehicle leaves the beam range because the beam width in the vertical direction of the radio waves transmitted from the transmitting unit only has a predetermined value (ordinarily, the beam width in the vertical direction is narrowed to perform accurate distance measurement). A situation occurs in which the rear end portion of the preceding vehicle cannot be detected.

Furthermore, for example, when the vehicle height of the preceding vehicle is high and the reflected waves are received from a plurality of portions of the vehicle body, such as a tires and the rear end portion of the vehicle body, it may be difficult to determine which reflected waves among the plurality of reflections are reflected by the target.

Therefore, first, the speed acquiring means acquires the speed of the own vehicle. When the speed is a predetermined value or lower and the distance from the own vehicle to the preceding vehicle (target) measured by the measuring means is a predetermined value or less, the preceding vehicle is determined to be a target to be detected. As a result, the preceding vehicle can be accurately determined to be the target.

In other words, when the predetermined value of the speed of the own vehicle is a speed immediately before the own vehicle stops, a target indicating that the distance to the preceding vehicle at this point is a predetermined value or less can be determined to be the target to be detected.

Furthermore, in addition to the determination based on the speed of the own vehicle and the distance from the own vehicle to the preceding vehicle, a portion of the change curve shape of the power values calculated by the shape calculating means indicating, among the local maximum values or inflection values at distances closer to the own vehicle than the distance corresponding to the maximum value of the power values, a local maximum value or an inflection value of the power values of which the difference in power with the maximum value of the power values is within a certain range may be determined to be the target to be detected.

As a result, as described above, even when the vehicle height of the preceding vehicle is high and reflected waves from a plurality of portions of the vehicle body, such as a tire and the rear end portion of the vehicle body, are present, the portion closest to the own vehicle is determined to be the target to be detected. Therefore, target determination can be more accurately performed.

For example, buildings, road signs, vehicles adjacent to the preceding vehicle, and the like are present ahead of the own vehicle, in addition to the preceding vehicle.

Reflected waves may also be generated therefrom.

Therefore, regarding a target that has once been determined to be a target, the target may be further determined to be a target when the distance and the orientation thereof are within a certain range from the position corresponding to the maximum value in the shape of the power calculated by the shape calculating means. As a result, only a target present within a predetermined area (distance and orientation) from the preceding vehicle is determined to be a target to be detected.

In other words, objects other than the preceding vehicle are no longer determined to be the target to be detected. Therefore, target determination can be more accurately performed.

In addition, as reflected waves that may be determined to be the target, reflected waves caused by clutter from a road surface may be considered in addition to the above-described reflected waves from objects.

Here, when a plurality of targets are determined to be the target to be detected, the relative speeds between the targets determined to be the target and the own vehicle are calculated. The target of which the calculated relative speed is within a predetermined range may be further determined to be the target to be detected.

As a result, because the relative speeds differ between the preceding vehicle and clutter, the preceding vehicle can be determined to be the target.

A target detecting method of an in-vehicle radar apparatus according to a second aspect of the present invention is that in which: a transmitting means transmits, in a forward direction of an own vehicle, radio waves having a predetermined beam width in a vertical direction; a receiving means receives, from a target positioned ahead of the own vehicle, reflected waves of the radio waves outputted from the transmitting means; a measuring means measures a distance from the own vehicle to the target based on reception power of the reflected waves received by the receiving means; a speed acquiring means acquires the speed of the own vehicle; a shape calculating means measures power values of the reception power of the reflected waves received by the receiving means in relation to the distance from the own vehicle and calculates a change curve shape of the measured power values; and a determining means determines, when the speed of the own vehicle acquired by the speed acquiring means is a predetermined value or less and the distance from the own vehicle to the target measured by the measuring means is a predetermined value or less, a portion of the change curve shape of the power values calculated by the shape calculating means as a target to be detected, the portion indicating, among local maximum values or inflection values of the power values at distances closer to the own vehicle than a maximum value of the power values, a local maximum value or inflection value of the power values of which a difference in power with the maximum value of the power values is within a predetermined range.

### BRIEF DESCRIPTION OF DRAWINGS

FIG. 1 is a block diagram of an overall configuration of an in-vehicle radar apparatus according to an embodiment of the present invention;

FIG. 2 is a flowchart of the flow of signal processing performed by a signal processing unit shown in FIG. 1;

FIGS. 3A to 3E are diagrams of a relationship between the distance to a preceding vehicle and the power of reflected waves from the preceding vehicle;

FIGS. 4A and 4B are conceptual diagrams of a method for determining whether or not the position of the preceding vehicle is within a prescribed area; and

FIG. 5 is a schematic block diagram of an internal configuration of the signal processing unit shown in FIG. 1.

### DESCRIPTION OF EMBODIMENTS

An embodiment to which the present invention is applied will hereinafter be described with reference to the drawings. The embodiment of the present invention is not limited in any way to the embodiment described below. Various embodiments are possible within the technical scope of the present invention.

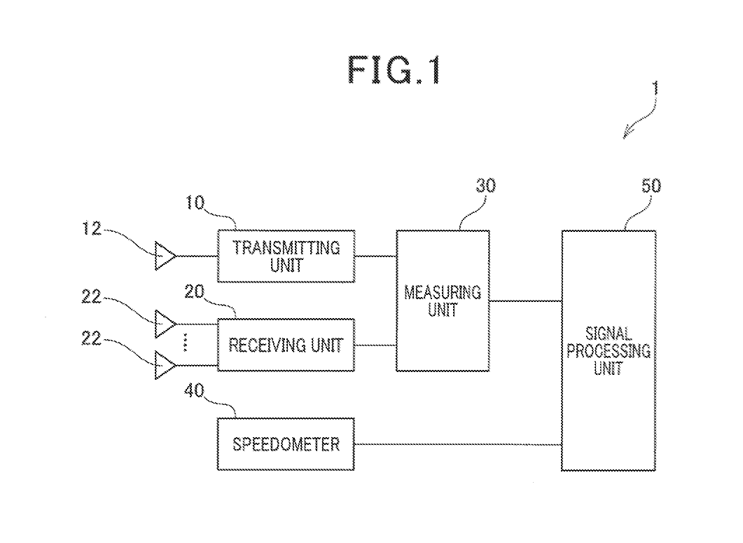

As shown in FIG. 1, an in-vehicle radar apparatus 1 has a device main body that has a predetermined shape enabling mounting in a front portion of a vehicle (such as a front bumper or a radiator grille [front grille]). Within the main body, the in-vehicle radar apparatus 1 includes a transmitting unit 10, a receiving unit 20, a measuring unit 30, a speedometer 40, and a signal processing unit 50.

The transmitting unit 10 is a device that outputs, in a forward direction of the vehicle, radio waves having a predetermined beam width in a vertical direction. The transmitting unit 10 includes a transmission antenna 12, as well as a high-frequency oscillator and a high-frequency amplifier (not shown).

The transmission antenna 12 is attached to the front bumper or the like of the own vehicle 5 and outputs FMCW radio waves outputted from the high-frequency oscillator in the forward direction of the own vehicle 5. In addition, the transmission antenna 12 is an antenna such as a horn antenna and is formed so that the beam width in the vertical direction is several degrees.

The receiving unit 20 is a device that receives, from a preceding vehicle 7, reflected waves of the radio waves outputted from the transmitting unit 10. The reception unit 20 includes a plurality of reception antennas 22, as well as a high-frequency amplifier and a modulator (not shown). The plurality of reception antennas 22 are array antennas in which a plurality of antenna elements, such as horn antennas, are disposed in a horizontal direction. The reception antennas 22 receive the reflected waves from the preceding vehicle 7 ahead of the own vehicle 5, and the like.

The high-frequency amplifier is a device that amplifies the reflected waves received by the plurality of reception antennas 22. The demodulator is a device that demodulates the reflected waves amplified by the high-frequency amplifier to frequencies and signal formats enabling signal processing.

The measuring unit 30 is a device that measures the distance from the own vehicle 5 to the preceding vehicle 7, orientation, and relative speed based on the reception power of the reflected waves received by the receiving unit 20.

According to the present embodiment, frequency modulated continuous waves (FMCW waves) are outputted from the transmission antenna 12 of the transmitting unit 10. The reflected waves reflected from the preceding vehicle 7 and the like are received by the plurality of reception antennas 22 of the receiving unit 20. The distance from the own vehicle 5 to the preceding vehicle 7 and the relative speed are measured based on the FMCW system.

In addition, the orientation of the reflected waves, or in other words, the orientation of a target, such as the preceding vehicle 7, in relation to the own vehicle 5 is measured from a phase difference in the reception waves received by the plurality of antenna elements configuring the reception antennas 22.

Regarding the details of the measuring method for distance and relative speed based on the FMCW system and the measuring method for orientation by the reception antennas 22 (array antennas), the methods are well-known. Therefore, detailed descriptions thereof are omitted.

The speedometer 40 acquires the speed of the own vehicle 5.

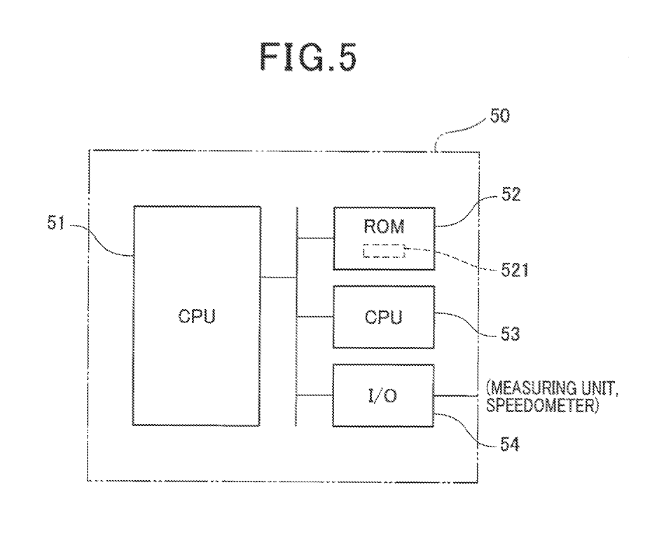

As shown in FIG. 5, the signal processing unit 50 includes a central processing unit (CPU) 51, a read-only memory (ROM) 52, a random access memory (RAM) 53, an input/output (I/O) 54, and the like. The signal processing unit 50 performs the following signal processing (1) to (5) (shape calculation process and determination process) by a program 521 stored in the ROM 52.

(1) When the speed of the own vehicle 5 acquired by the speedometer 40 is a predetermined value or lower and the distance from the own vehicle 5 to the preceding vehicle 7 measured by the measuring unit 30 is a predetermined value or less, the preceding vehicle 7 is determined to be a target.

(2) Power values of the reception power of the radio waves (reflected waves) received by the receiving unit 20 in relation to the distance from the own vehicle 5 are measured. A change curve shape (waveform) of the power values of the reception power of the measured reflected waves in relation to the distance from the own vehicle 5 is calculated (shape calculation process).

(3) A section of the change curve shape of the power values of the reception power of the reflected waves in relation to the distance from the own vehicle 5, calculated by the shape calculation process, is determined to be a target to be detected, the section indicating a local maximum value or an inflection value of the power values of which the difference in power with the maximum value of the power values is within a certain range, among local maximum values and inflection values at distances closer to the own vehicle 5 than a distance corresponding to the maximum value of the power values (determination process).

(4) When the distance and the orientation measured by the measuring unit 30 of an object determined to be a target are within a certain range from the position corresponding to the maximum value of the power values within the change curve shape of the power values in relation to the distance, calculated by the shape calculation process, the object is determined to be a target to be detected (determination process).

(5) When a plurality of objects are determined to be a target, an object of which the relative speed between the target and the own vehicle 5 calculated by the measuring unit 30 is within a predetermined range is further determined to be the target to be detected (determination process).

In the signal processing performed by the above-described signal processing unit 50, the shape calculation process and the determination process correspond to a shape calculating means and a determining means.

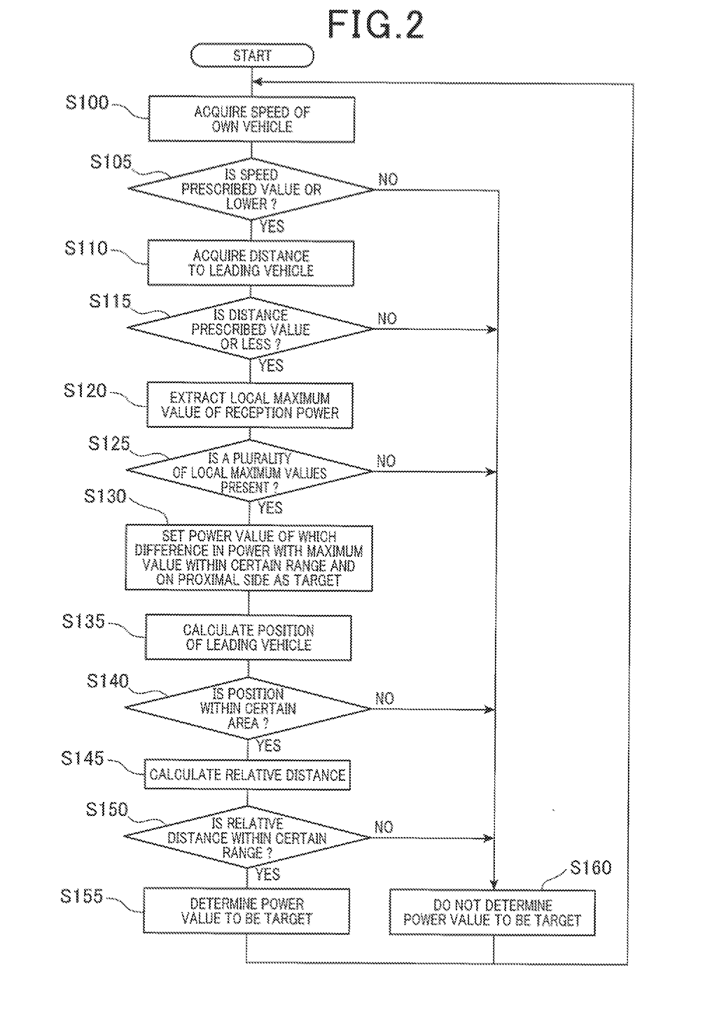

Next, details of the signal processing performed by the signal processing unit 50 will be described with reference to the flowchart in FIG. 2.

The signal processing is performed as the program 521 stored in the ROM 52 of the signal processing unit 50. The process is started when the signal processing unit 50 is turned ON. When the process is started, first, at step S100, the CPU 51 acquires the speed of the own vehicle from the speedometer 40.

At subsequent step S105, the CPU 51 determines whether or not the speed v1 of the own vehicle 5 acquired at step S100 is a prescribed value V_{ref1} set in advance or lower. When determined that the speed v1 of the own vehicle 5 is the prescribed value V_{ref1} or lower (Yes at step S105), the CPU 51 proceeds to step S110. When determined that the speed v1 is higher than the prescribed value V_{ref1} (No at step S105), the CPU 51 proceeds to Step S160.

At step S110, the CPU 51 acquires the distance D1 to the preceding vehicle 7 from the measuring unit 30. At subsequent step S115, the CPU 51 determines whether or not the distance D1 to the preceding vehicle 7 acquired at step S110 is a prescribed value D_{ref1} set in advance or less. When determined that the distance D1 to the preceding vehicle 7 is the prescribed value D_{ref1} or less (Yes at step S115), the CPU 51 proceeds to step S120. When determined that the distance D1 is greater than the prescribed value D_{ref1} (No at step S115), the CPU 51 proceeds to step S160.

At step S120, the CPU 51 extracts local maximum values and inflection values of the power values from the change curve shape (waveform) of the power values of the reception power in relation to the distance from the own vehicle 5. In other words, the CPU 51 acquires, from the measuring unit 30, the power values of the reception power in relation to the distance to the own vehicle 5. The CPU 51 calculates the change curve shape of the acquired power values of the reception power in relation to the distance from the own vehicle 5, and extracts the local maximum values or inflection values of the power values from the calculated change curve shape of the power values of the reception power in relation to the distance from the own vehicle 5.

At subsequent step S125, the CPU 51 extracts the maximum value pₘₐₓ of the power values among the local maximum values and inflection values of the power values extracted at step S120, and determines whether a power value is present that indicates a local maximum value or an inflection value of the power values at a distance closer to the own vehicle 5 than a distance dₘₐₓ indicating the maximum value pₘₐₓ of the extracted power values. As a result, when determined that a power value is present that indicates a local maximum value or an inflection value of the power values at a distance close to the own vehicle 5 (Yes at step S125), the CPU 51 proceeds to step S130. When determined otherwise (No at step S125), the CPU 51 proceeds to step S160.

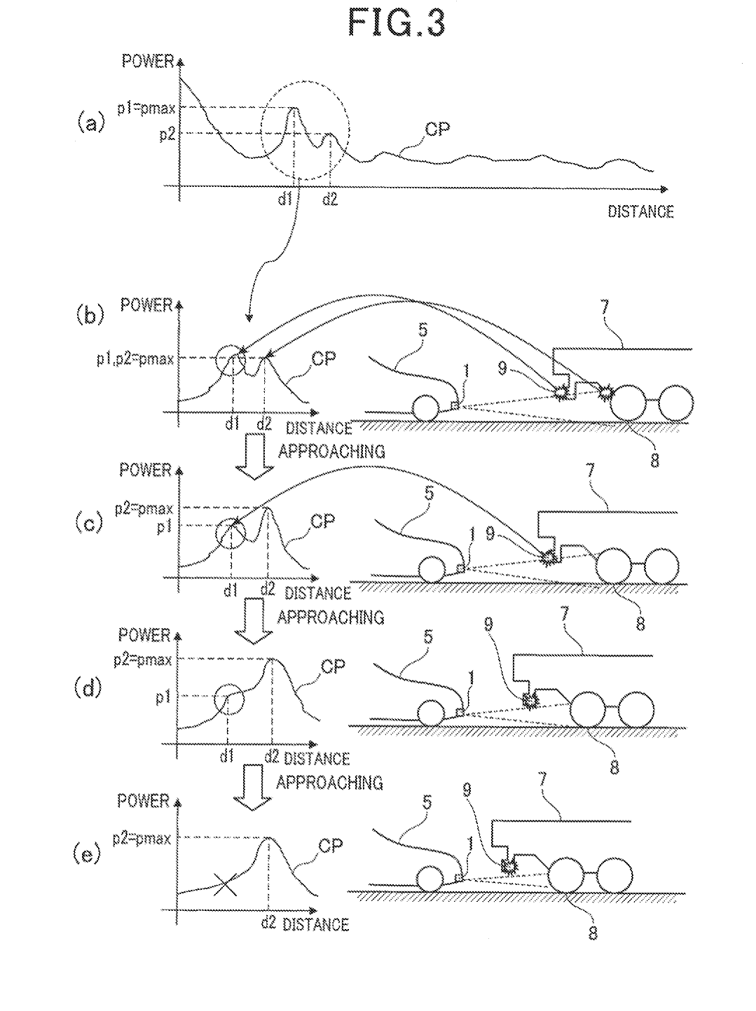

At step S130, the CPU 51 sets, among the plurality of local maximum values and inflection values of the power values, the power value of which difference in power Δp with the maximum value pₘₐₓ of the power values is within a certain range and indicates a local maximum value or an inflection value at a distance closer to the own vehicle 5 than the distance dₘₐₓ indicating the maximum value pₘₐₓ of the power values as a target. In other words, when a graph is created with the distance from the own vehicle 5 to the preceding vehicle 7 on a horizontal axis and the power value of the reception power of the reflected waves received by the receiving unit 20 on a vertical axis, as shown in FIG. 3A, in the change curve shape CP of the power values of the reception power of the reflected waves in relation to the distance from the own vehicle 5, the power values may indicate a plurality of local maximum values or inflection values (two local maximum values p1 and p2 in FIG. 3A) at a plurality of distances (two distances d1 and d2 in FIG. 3A) near the own vehicle 5.

FIGS. 3B to 3E are expanded views of areas including the two local maximum values p1 and p2 of the power values in FIG. 3A. Here, when the distance between the own vehicle 5 and the preceding vehicle 7 is the distance shown in FIG. 3B (a relatively far distance in relation to the distances shown in FIGS. 3C and 3D), among the plurality of local maximum values or inflection values of the power values extracted from the change curve shape CP of the power values of the reception power of the reflected waves in relation to the distance from the own vehicle 5 (the two local maximum points p1 and p2 in FIG. 3B), the reception power of the reflected waves from a tire 8 of the preceding vehicle 7 corresponding to distance d1 and the reception power of the reflected waves from a bumper 9 of the same preceding vehicle at distance d2 indicate similar power values p1 and p2.

Conversely, as the own vehicle 5 approaches the preceding vehicle 7, as shown in FIGS. 3C and 3D, the power value p1 of the reception power of the reflected waves from the bumper 9 becomes smaller than the power value p2 of the reception power of the reflected waves from the tire 8. As the own vehicle 5 further approaches, as shown in FIG. 3E, the reflected waves from the bumper 9 are no longer detected.

In this way, when the power values in the change curve shape CP of the power values of the reception power of the reflected waves in relation to the distance from the own vehicle 5 indicate a plurality of local maximum values and inflection values, the power value indicating a local maximum value or an inflection value at a distance close to the own vehicle 5 is set as the target to be detected. For example, in FIGS. 3C and 3D, the two local maximum values p1 and p2 of the power values are extracted from the change curve shape CP of the power values of the reception power in relation to distance. In this instance, because p2 is greater than p1, p2 is extracted as the maximum value pₘₐₓ. However, the distance d1 corresponding to p1 is less than the distance d2 corresponding to p2 (=pₘₐₓ) and is closer to the own vehicle 5. Therefore, the portion of the preceding vehicle 7 corresponding to p1, or in other words, the bumper 9 portion is determined to be the target to be detected.

At step S135, the CPU 51 calculates a position Fp from the own vehicle 5 to the preceding vehicle 7. In other words, the CPU 51 acquires the orientation of the preceding vehicle 7 in relation to the own vehicle 5 from the measuring unit 30. The CPU 51 then calculates the position Fp of the preceding vehicle 7 from the acquired orientation and the distance to the preceding vehicle 7 acquired at step S110.

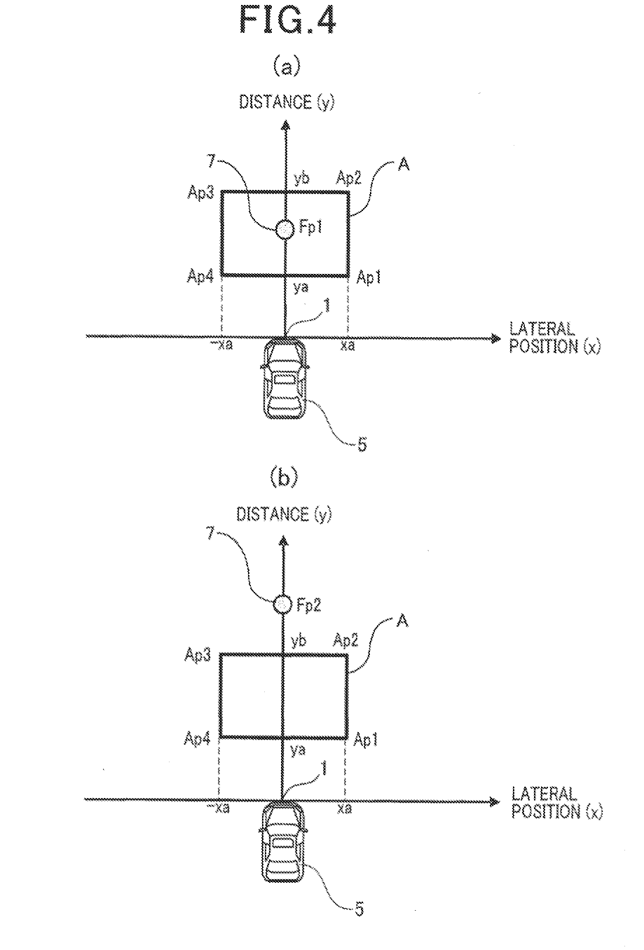

At subsequent step S140, the CPU 51 determines whether or not the position Fp of the preceding vehicle 7 calculated at step S135 is within a prescribed area set in advance. For example, in the examples in FIGS. 4A and 4B, with the position of the in-vehicle radar apparatus 1 mounted in the front portion of the own vehicle 5 as reference (point of origin), in planar Cartesian coordinates (xy coordinates) prescribed by a position in the lateral direction thereof (lateral position: x coordinate in FIGS. 4A and 4B) and a position in the forward direction (distance: y coordinate in FIGS. 4A and 4B), whether or not the position Fp of the preceding vehicle 7 is within a prescribed area A set in advance (in FIGS. 4A and 4B, a rectangular area surrounded by four apexes AP1 (xa,ya), AP2 (xa,yb), AP3 (−xa,yb), and AP4 (−xa,ya)) is determined. For example, in the examples in FIGS. 4A and 4B, when the position Fp of the preceding vehicle 7 is Fp(x,y), whether or not relationships −xa≦x≦xa and ya≦y≦yb are met is determined.

Then, when the position Fp of the preceding vehicle 7 is within the prescribed area A as indicated by position Fp1 (x1,y2) (−xa≦x1=0≦xa, ya≦y1≦yb) in FIG. 4A (Yes at step S140), the CPU 51 proceeds to step S145. When the position Fp of the preceding vehicle 7 is not within the prescribed area A as indicated by position Fp2 (x2,y2) (−xa≦x2=0≦xa, yb<y1) in FIG. 4B (No at step S140), the CPU 51 proceeds to step S160. The coordinate system used in the processes at steps S135 to S150 is not limited to a planar Cartesian coordinate system such as that shown in FIGS. 4A and 4B. Any coordinate system, such as a polar coordinate system, is applicable as long as the positional relationship between the position of the preceding vehicle 7 and the prescribed area A is determined from the orientation and distance of the preceding vehicle 7.

At step S145, the CPU 51 acquires the relative speed between the own vehicle 5 and the preceding vehicle 7 from the measuring unit 30.

At subsequent step S150, the CPU 51 determines whether or not the relative speed V2 acquired at step S145 is within a prescribed range set in advance, or in other words, a relationship V_{ref2A}≦V2≦V_{ref2B} (V_{ref2A} and V_{ref2B} respectively indicating a lower limit reference value and an upper limit reference value set in advance) is satisfied. When determined that the relative speed V2 is within the prescribed range (Yes at step S150), the CPU 51 proceeds to step S155. When determined that the relative speed V2 is not within the prescribed range (No at step S150), the CPU 51 proceeds to step S160.

At step S155, the CPU 51 determines the preceding vehicle 7 to be the target. The CPU 51 then returns to step S100 and repeats signal processing. At step S160, the CPU 51 returns to step S100 without determining the preceding vehicle 7 to be the target, and repeats signal processing.

In the in-vehicle radar apparatus 1 such as that described above, the distance to the preceding vehicle 7 can be measured by the receiving unit 20 receiving, from the preceding vehicle 7, the reflected waves of the radio waves outputted from the transmitting unit 10.

At this time, when the own vehicle 5 and the preceding vehicle 7 stop, such as at a red light, the own vehicle 5 approaches the preceding vehicle 7 while decelerating. Then, as shown in FIG. 3E, when the own vehicle approaches the stopped preceding vehicle 7 that has a high vehicle height, the rear end portion of the preceding vehicle 7 leaves the beam range because the beam width in the vertical direction of the radio waves outputted from the transmitting unit 10 is narrow. A situation occurs in which the rear end portion of the preceding vehicle 7 cannot be detected.

Here, when the speedometer 40 acquires the speed of the own vehicle 5 and the speed is a predetermined value (the speed immediately before the own vehicle 5 stops) or lower, and the distance from the own vehicle 5 to the preceding vehicle 7 measured by the measuring unit 30 is a predetermined value or less, the preceding vehicle 7 is determined to be a target. Therefore, the preceding vehicle 7 can be determined to be the target.

Furthermore, a portion that corresponds to a local maximum value or an inflection value of the power values of which the difference in power with the maximum value of the power values is within a certain range and is at a distance closer to the own vehicle 5 than the maximum value of the power values, among the local maximum values and inflection values extracted from the chance curve shape of the power values of the reception power of the reflected waves in relation to the distance from the own vehicle, is determined to be a target. Therefore, for example, even when the vehicle height of the preceding vehicle 7 is high and the reflected waves are received from a plurality of portions of the vehicle body, such as a tire and the rear end portion of the vehicle body, the portion closest to the own vehicle 5 is determined to the target. Therefore, target determination can be more accurately performed.

In addition, when a portion that has once been determined to be a target is further determined to be a target when the distance and the orientation of the portion are within a predetermined range from the position of the target corresponding to the maximum value extracted from the power shape, only a target that is present within a certain area (distance and orientation) ahead of the own vehicle 5 is determined to be a target. In other words, objects other than the preceding vehicle 7 are no longer determined to be targets. Therefore, target determination can be more accurately performed.

Furthermore, when a plurality of portions determined to be the target are present, the relative speeds between the portions determined to be the target and the own vehicle 5 are calculated. The portion of which the calculated relative speed is within a predetermined range is further determined to be the target. Then, because the relative speeds differ between the preceding vehicle 7 and clutter, the preceding vehicle 7 can be determined to be the target. In other words, the preceding vehicle 7 can be accurately determined to be the target to be detected without being affected by noise.

An embodiment of the present invention is described above. However, the present invention is not limited to the present embodiment and various embodiments are possible.

For example, in the in-vehicle radar apparatus 1 and the target detection method thereof according to the above-described embodiment, the FMCW system for measuring distance and relative speed between the own vehicle 5 and the preceding vehicle 7 or the like is used. However, similar effects can be achieved when a pulse-Doppler system is used as well.

In addition, the in-vehicle radar apparatus 1 and the target detection method thereof according to the above-described embodiment can be applied, for example, to an in-vehicle radar used in an inter-vehicle control apparatus that controls vehicle cruising to maintain a fixed inter-vehicle distance to a preceding vehicle, an in-vehicle radar used in a collision mitigation system that reduces injuries to passengers, such as by automatically operating the brakes or tightening the seatbelts, when a collision with a preceding vehicle is determined to be difficult to avoid, and the like.

### REFERENCE SIGNS LIST

1: in-vehicle radar apparatus
5: own vehicle
7: preceding vehicle
8: tire
9: bumper
10: transmitting unit
12: transmission antenna
20: receiving unit
22: reception antenna
30: measuring unit
40: speedometer
50: signal processing unit
51: CPU
52: ROM
53: RAM
54: I/O
521: program

What is claimed is:

1. An in-vehicle radar apparatus comprising:
transmitting means that transmits, in a forward direction of an own vehicle, radio waves having a predetermined beam width in a vertical direction;
receiving means that receives, from a target positioned ahead of the own vehicle, reflected waves of the radio waves outputted from the transmitting means;
measuring means that measures a distance from the own vehicle to the target based on reception power of the reflected waves received by the receiving means;
speed acquiring means that acquires the speed of the own vehicle;
shape calculating means that measures power values of the reception power of the reflected waves received by the receiving means in relation to the distance from the own vehicle and calculates a change curve shape of the measured power values; and
determining means that determines, as a target to be detected, a portion of the change curve shape of the power values calculated by the shape calculating means, when the speed of the own vehicle acquired by the speed acquiring means is a predetermined value or less and the distance from the own vehicle to the target measured by the measuring means is a predetermined value or less, a portion of the change curve shape of the power values calculated by the shape calculating means as a target to be detected, the portion of the change curve shape indicating, among local maximum values or inflection values of the power values at distances closer to the own vehicle than a maximum value of the power values, a local maximum value or inflection value of the power values of which a difference in power with the maximum value of the power values is within a predetermined range.

2. The in-vehicle radar apparatus according to claim 1, wherein:
the measuring means measures an orientation of the target in relation to the own vehicle, in addition to the distance from the own vehicle to the target; and
the determining means further determines, when determining the target to be detected, the target to be the target to be detected when the distance to the target and the orientation measured by the measuring means are within a certain area from the position of a target corresponding to the maximum value of the power values extracted by the shape calculating means.

3. The in-vehicle radar apparatus according to claim 2, further comprising:
relative speed calculating means that calculates a relative speed between the target and the own vehicle, wherein
the determining means further determines, when a plurality of targets are determined to be the targets when determining the target, the target of which the relative speed between the target and the own vehicle calculated by the relative speed calculating means is within a predetermined range as the target for detection, among the plurality of targets.

4. The in-vehicle radar apparatus according to any one claim 1, wherein:
the target to be detected is a preceding vehicle traveling ahead of the own vehicle.

5. A target detection method of an in-vehicle radar apparatus wherein:
transmitting, by transmitting means, in a forward direction of an own vehicle, radio waves having a predetermined beam width in a vertical direction;
receiving, by receiving means, from a target positioned ahead of the own vehicle, reflected waves of the radio waves outputted from the transmitting means;
measuring, by measuring means, a distance from the own vehicle to the target based on reception power of the reflected waves received by the receiving means;
acquiring, by speed acquiring means, the speed of the own vehicle;
measuring, by shape calculating means, power values of the reception power of the reflected waves received by the receiving means in relation to the distance from the own vehicle and calculates a change curve shape of the measured power values; and
determining, by determining means, as a target to be detected, a portion of the change curve shape of the power values calculated by the shape calculating means, when the speed of the own vehicle acquired by the speed acquiring means is a predetermined value or less and the distance from the own vehicle to the target measured by the measuring means is a predetermined value or less, the portion of the change curve shape indicating, among local maximum values or inflection values of the power values at distances closer to the own vehicle than a maximum value of the power values, a local maximum value or inflection value of the power values of which a difference in power with the maximum value of the power values is within a predetermined range.

6. The target detection method of an in-vehicle radar apparatus according to claim 5, wherein:
the measuring means measures an orientation of the target in relation to the own vehicle, in addition to the distance from the own vehicle to the target; and
the determining means further determines, when determining the target to be detected, the target to be the target to be detected when the distance to the target and the orientation measured by the measuring means are within a certain area from the position of a target corresponding to the maximum value of the power values extracted by the shape calculating means.

7. The target detection method of an in-vehicle radar apparatus 1 according to claim 6, wherein:
a relative speed calculating means calculates a relative speed between the target and the own vehicle; and
the determining means further determines, when a plurality of targets are determined to be the target when determining the target, the target of which the relative speed between the target and the own vehicle calculated by the relative speed calculating means is within a predetermined range as the target for detection, among the plurality of targets.

8. The target detection method of an in-vehicle radar apparatus according to claim 5, wherein
the target to be detected is a preceding vehicle traveling ahead of the own vehicle.

9. The in-vehicle radar apparatus according to claim 2, wherein:
the target to be detected is a preceding vehicle traveling ahead of the own vehicle.

10. The in-vehicle radar apparatus according to claim 3, wherein:
the target to be detected is a preceding vehicle traveling ahead of the own vehicle.

11. The target detection method of an in-vehicle radar apparatus according to claim 6, wherein
the target to be detected is a preceding vehicle traveling ahead of the own vehicle.

12. The target detection method of an in-vehicle radar apparatus according to claim 7, wherein
the target to be detected is a preceding vehicle traveling ahead of the own vehicle.
